(19) United States
(12) Patent Application Publication
(10) Pub. No.: US 2017/0328382 A1
(43) Pub. Date: Nov. 16, 2017

(54) HYDRAULIC SYSTEM FOR CONTROLLING AN IMPLEMENT

(71) Applicant: Robert Bosch GmbH, Stuttgart (DE)

(72) Inventors: Jan Amrhein, Simpsonville, SC (US); Richard F. Sailer, JR., Massillon, OH (US)

(21) Appl. No.: 15/154,237

(22) Filed: May 13, 2016

(51) Int. Cl. F15B 13/04; F15B 13/06; F15B 11/08; F15B 11/16

(52) U.S. Cl. CPC F15B 13/0402; F15B 11/16; F15B 13/06; F15B 11/08; F15B 2211/255; F15B 2211/426; F15B 2211/20546

(57) ABSTRACT

A hydraulic system is provided for controlling one or more piston-cylinders of an implement. An implement valve includes at least one spool operable to transition between a neutral position and an open position. A variable displacement pump is operable to move a fluid from a reservoir into a supply conduit and to the at least one spool. A flow control valve, distinct and separate from the at least one spool is located in-line with the supply conduit between the variable displacement pump and the at least one spool, and is operable to simultaneously provide the fluid to the implement valve and to a bypass pathway. The bypass pathway extends from the flow control valve to the reservoir without intervening valving. Each of the at least one spool is operable to permit increased fluid flow to a corresponding piston cylinder of the implement when in the open position. The variable displacement pump is operable to vary a flow rate to maintain a predetermined pump margin across the flow control valve.

### BACKGROUND

The present invention relates to hydraulic systems for controlling an implement (e.g., a bucket, a backhoe, a dozer, etc.) of a skid steer loader or similar hydraulic machinery. Traditionally, the implement is controlled via an open center valve or spool that is hydraulically connected to a fixed displacement pump. In order to improve efficiency, a variable displacement pump (i.e., utilizing a swash plate) can replace the fixed displacement pump. When using a variable displacement pump, additional components such as pressure compensators or additional valve channels within the implement valve spool must be provided to continuously adjust the pump displacement. U.S. Pat. No. 8,215,107 to Husco International Inc. provides a method of controlling the swash angle of a variable displacement pump by introducing additional valve flow control channels into each implement valve spool. U.S. Pat. No. 5,715,865 to Husco International Inc. discloses one such system which utilizes individual pressure compensators. The additional components (i.e., one pressure compensator per valve section, shuttle valves, etc.) necessary to implement the system of U.S. Pat. No. 5,715,865 add cost and complexity to the hydraulic system.

### SUMMARY

The invention provides, in one aspect, a hydraulic system for controlling one or more piston-cylinders of an implement. An implement valve includes at least one spool operable to transition between a neutral position and an open position. A variable displacement pump is operable to move a fluid from a reservoir into a supply conduit and to the at least one spool. A flow control valve, distinct and separate from the at least one spool is located in-line with the supply conduit between the variable displacement pump and the at least one spool, and is operable to simultaneously provide the fluid to the implement valve and to a bypass pathway. The bypass pathway extends from the flow control valve to the reservoir without intervening valving. Each of the at least one spool is operable to permit increased fluid flow to a corresponding piston cylinder of the implement when in the open position. The variable displacement pump is operable to vary a flow rate to maintain a predetermined pump margin across the flow control valve.

The invention provides, in another aspect, a method for controlling a spool of a hydraulic system to actuate a piston-cylinder of an implement. A variable displacement pump is provided in receptive fluid communication with a reservoir. The variable displacement pump is in selective fluid communication with the spool via a flow control valve distinct from the spool. The spool is actuated to establish fluid communication between the variable displacement pump and the piston-cylinder. The flow control valve is actuated simultaneously with the spool to adjust a flow rate through the variable displacement pump independent of the spool position. A predetermined pump margin is maintained across the flow control valve by providing the fluid to both the spool and a bypass pathway through the flow control valve. The bypass pathway extends from the flow control valve to the reservoir without intervening valving.

The invention provides, in yet another aspect, a hydraulic system for controlling one or more piston-cylinders of an implement. An implement valve includes at least one spool operable to transition between a neutral position and an open position. A variable displacement pump is operable to move a fluid from a reservoir into a supply conduit and to the at least one spool. A return conduit is operable to return the fluid from the at least one spool to the reservoir. A flow control valve, distinct and separate from the at least one spool, is located in-line with the supply conduit between the variable displacement pump and the at least one spool. A bypass pathway extends from the flow control valve to the reservoir without intervening valving. A first flow path extends from the variable displacement pump, across the flow control valve to the at least one spool. A second flow path extends across the flow control valve to the reservoir via the bypass pathway. The variable displacement pump is operable to vary a flow rate to maintain a predetermined pump margin across the flow control valve.

Other features and aspects of the invention will become apparent by consideration of the following detailed description and accompanying drawings.

### BRIEF DESCRIPTION OF THE DRAWINGS

FIG. 1 is a schematic diagram of a hydraulic system including three spools of an implement valve and a variable displacement pump.

FIG. 2 illustrates the hydraulic system of FIG. 1 and displays an exemplary path which is taken by the fluid in order to move an implement.

FIG. 3 is a graph of spool stroke versus flow area of the flow control valve.

FIG. 4 is a schematic representation of a flow control valve of the hydraulic system in a neutral position.

FIG. 5 is a schematic representation of the flow control valve in an actuated position.

FIG. 6 is a schematic representation of the flow control valve in a maximum stroke position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

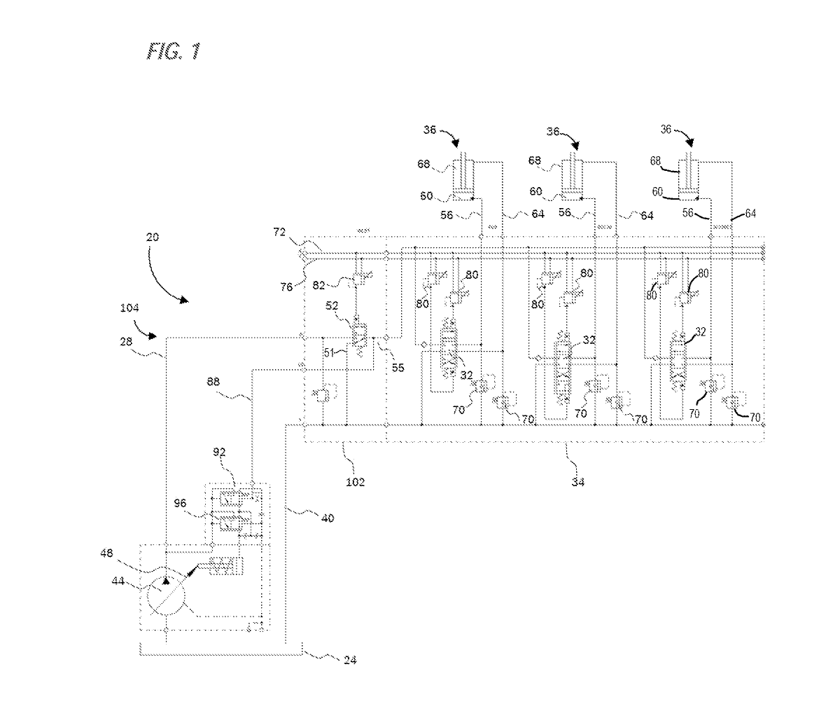

A hydraulic system 20 includes a reservoir 24, configured to store a quantity of fluid (e.g., hydraulic fluid, oil, water, etc.). A supply conduit 28, in fluid communication with the reservoir 24, is configured to transfer fluid from the reservoir 24 to at least one spool 32 of an implement valve 34 to control operation of a consumer or piston-cylinder 36 of an implement. The piston-cylinders 36 of FIG. 1 may represent various functions of any hydraulic implement controllable by a closed center valve or three-position valve. Alternatively, the piston-cylinders 36 may represent hydraulic functions of multiple different implements. Alternatively, a different valve such as a two position valve (i.e., open, closed), or a many (i.e., four or more) position valve may control the piston-cylinder 36. A return conduit 40 is provided to return fluid to the reservoir 24. The supply conduit 28, as shown, includes all conduits downstream of a variable displacement pump 44, upstream of the spools 32, and in fluid communication with the variable displacement pump 44 (excluding a load sensing conduit 88, as described below). The return conduit 40, as shown, includes all conduits of the hydraulic system 20 directly upstream of the reservoir 24 (i.e., no valves exist between the return conduit 40 and the reservoir 24).

The variable displacement pump 44 is located in line with the supply conduit 28 to move the fluid from the reservoir 24 towards the spools 32. The variable displacement pump 44 may be an axial piston pump including a plurality of pistons coupled to a swash plate 48. The angle of the swash plate 48 is capable of being adjusted from a minimum value (e.g., 0 degrees) corresponding to minimum or no flow, to a maximum value corresponding to maximum flow rate, and maintaining a plurality of intermediate angular positions therebetween. When at a minimum value, the pump rotates but the swash plate 48 prohibits the pistons from reciprocating such that fluid does not flow from the reservoir 24 through the variable displacement pump 44. When at an intermediate or maximum value (i.e., any value excluding the minimum value), the flow rate generated by the variable displacement pump 44 varies in relation to the angle of the swash plate 48. From the variable displacement pump 44, the fluid travels through the supply conduit 28 to a flow control valve 52.

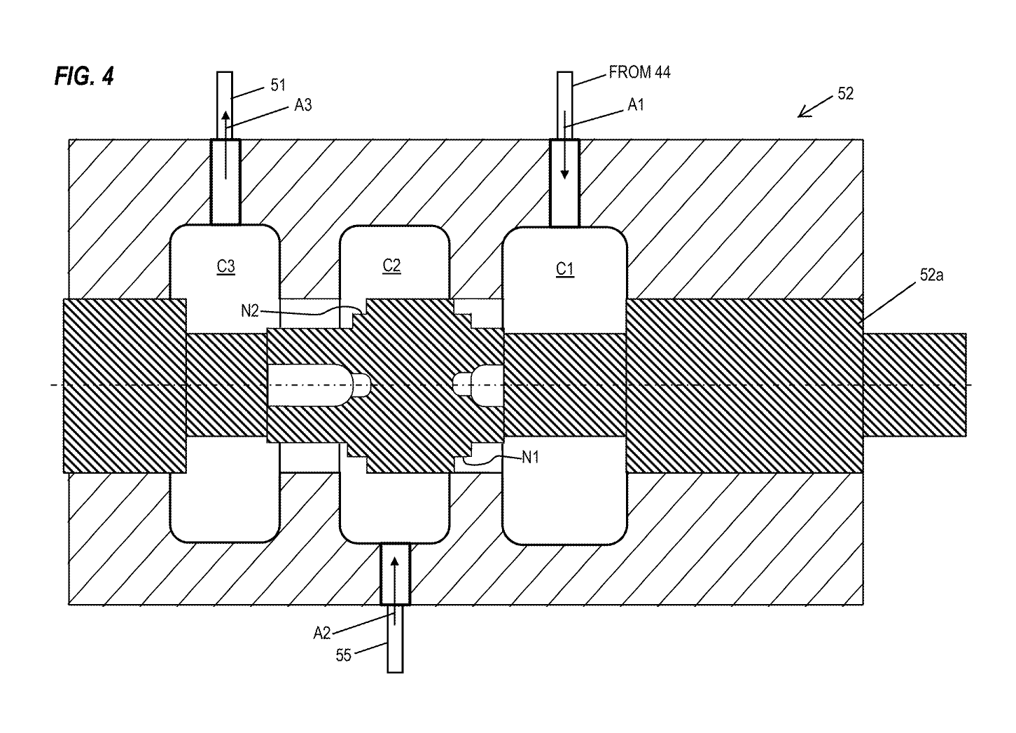

The flow control valve 52 is located in line with the supply conduit 28 and is actuated to control the swash angle of the variable displacement pump 44. When the flow control valve 52 is in an actuated position, a predetermined pump margin (i.e., pressure differential) is maintained across the flow control valve 52. As shown in FIG. 4, in a neutral position (i.e., not actuated), a valve member 52a of the flow control valve 52 is positioned to prohibit fluid flow from the variable displacement pump 44 (i.e., at arrow A1) to conduit portion 55 (i.e., at arrow A2) of the supply conduit 28 and to the spools 32. Conduit portion 55 is located between the flow control valve 52 and the spools 32. As shown in FIG. 4, when the flow control valve 52 is in the neutral position, fluid from the conduit portion 55 (i.e., at arrow A2) flows to a return line 40 (i.e., at arrow A3) and more specifically to a bypass pathway 51. The bypass pathway 51 extends from the flow control valve 52 to the reservoir 24 without any intervening valving (i.e., the flow of the fluid is not controlled by any element within the bypass pathway 51).

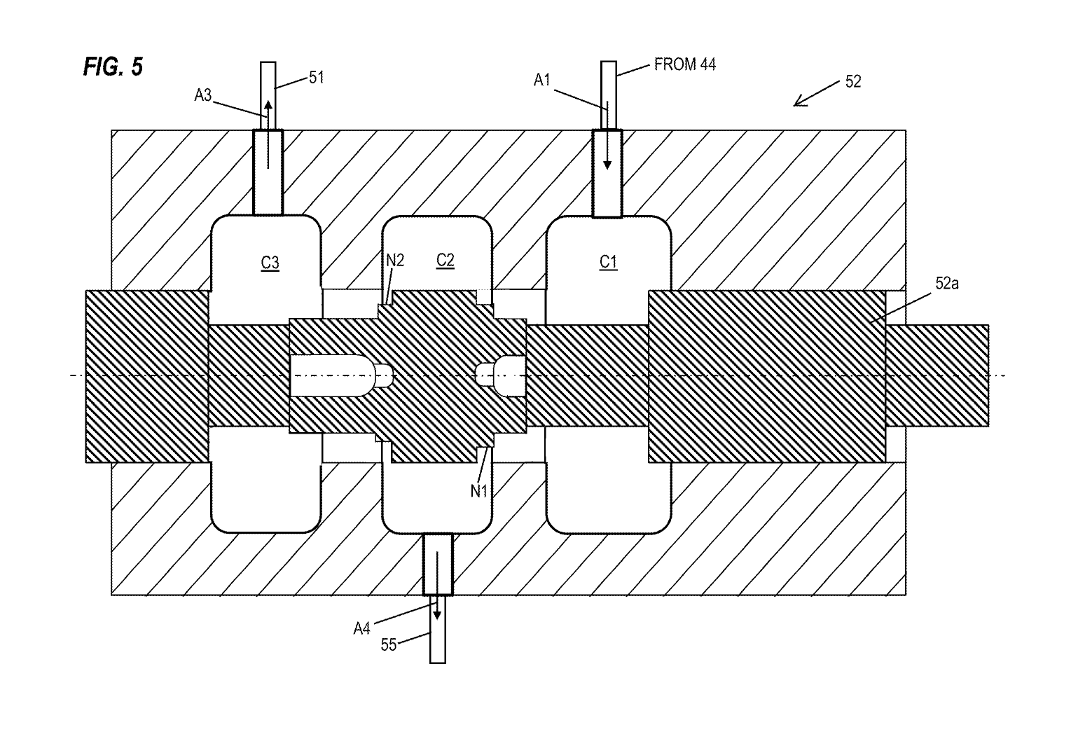

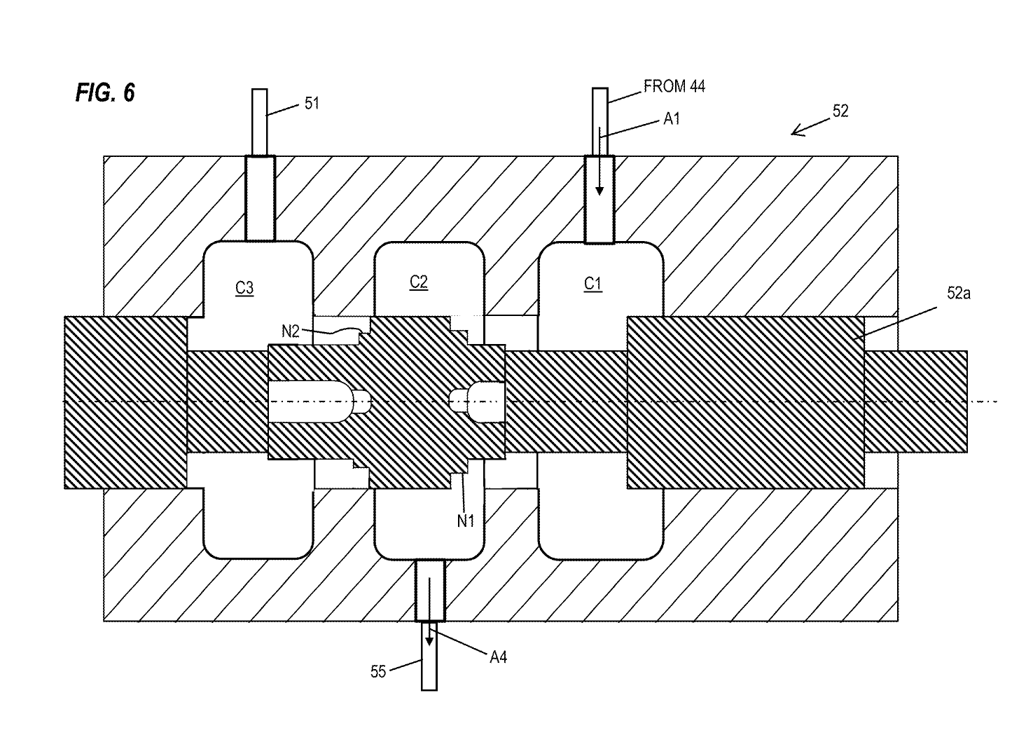

The flow control valve 52 may be electrically or electro-hydraulically actuated. Though the spools 32 may be actuated in tandem with the flow control valve 52, the flow control valve 52 is actuated independent of the spools 32, and is distinct and separate from the spools 32. Since the flow control valve 52 is configured to control the swash angle, the spools 32 do not include any flow control channels to control the swash angle of the variable displacement pump 44. As the restriction of the flow control valve 52 is lessened, flow through the variable displacement pump 44 increases to maintain the predetermined pump margin during use of the implement as directed by the spool(s) 32. As shown in FIGS. 5-6, the flow path from the pump 44 (i.e., at arrow A1), across the flow control valve 52, and to conduit portion 55 (i.e., at arrow A4) and the spools 32 defines a first flow path.

In addition, the valve member 52a of the flow control valve 52 includes a control notch N1 which is movable with the valve member 52a to provide a connection between chambers C1 and C2. As shown in FIG. 5, the displaced control notch N1 also connects the pump 44 (i.e., at arrow A1), through the flow control valve 52, to the return line 40 and further to the bypass pathway 51 past another control notch N2 in the valve member 52a. The path past the control notch N2 defines a second flow path. When the control valve 52 is in a neutral position (FIG. 4), the control notch N2 to the return line 40 from the conduit portion 55 (i.e., between chambers C2 and C3) provides a flow path from the conduit portion 55 at a maximum flow area. The flow area is reduced when the control valve 52 is actuated (FIG. 5). The control notch N2 may close completely over the stroke of the valve. As shown in FIG. 6, when the valve member 52a is at a maximum stroke, the control notch N2 closes the second flow path.

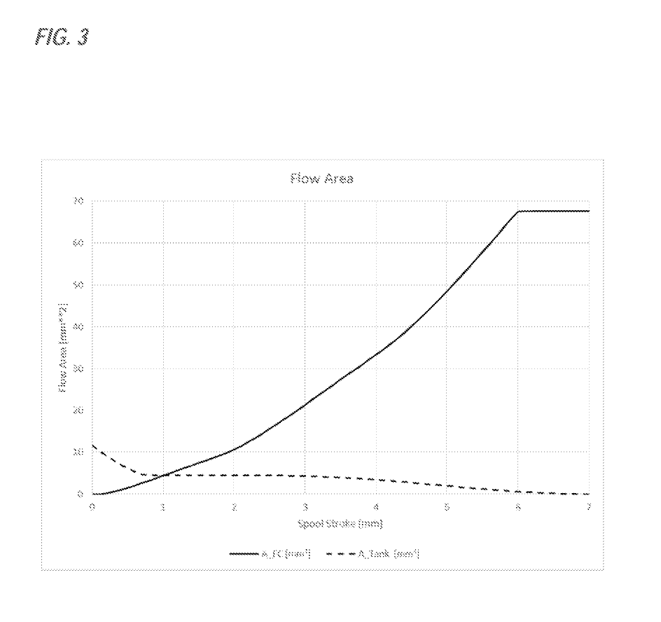

FIG. 3 shows an example of the flow area past the control notches N1, N2 (i.e., connection from pump 44 to conduit portion 55 and connection from conduit portion 55 to the bypass pathway 51) on valve 52 relative to the spool stroke. As shown by the dashed line, as the spool stroke increases, the flow area past the control notch N2 to the bypass pathway 51 decreases a maximum area at zero spool displacement to a minimum area at maximum spool displacement As shown by the solid line, as the spool stroke increases, the flow area past the control notch N1 to the conduit portion 55 increases from a minimum value at zero spool displacement to a maximum value at full spool displacement. Therefore, when the control valve 52 is in the closed or neutral position (i.e., 0 mm spool stroke), any pressure in conduit portion 55 or load sensing conduit 88 (explained in greater detail below) is released to the bypass conduit 51, return conduit 40, and the reservoir 24.

When the valve 52 is moved to an open or actuated position (i.e., not the neutral position), the connection from the pump 44 to the conduit portion 55 across the valve 52 is opened and the swash plate 48 of the variable displacement pump 44 swivels out to provide an increased flow to the supply conduit 28. At the same time, the flow area of the connection from conduit portion 55 to the bypass conduit 51 decreases and may close entirely.

As shown in FIG. 1, each of the piston-cylinders 36 includes a first variable volume chamber 60, and a second variable volume chamber 68 opposite the first variable volume chamber 60 with a piston 38 located between. The spool 32 provides increased fluid pressure to one of the variable volume chambers 60, 68, and drains the other, thereby moving the piston 38. The hydraulic actuation of the piston 36 controls movement of the implement.

The flow control valve 52 is actuated to open when at least one of the spools 32 is actuated to open. The flow control valve 52 may open an amount proportional to the spools 32, but as the flow control valve 52 is separate from the spools 32, this is not necessary. As shown in FIG. 1, the spools 32 may be closed center valves configured to transition between a neutral position, a forward position and a reverse position. Each spool 32 is biased towards the neutral position, such that when no input is provided via a pilot pressure supply line 72 and a pilot pressure drain line 76, the spool 32 is in the neutral position.

In order to actuate one of the spools 32 from the neutral position into either the forward position or the reverse position (i.e., an open position), a corresponding operator control (i.e., joystick, button, pedal, etc.) is manipulated. If, for example, the operator control is a joystick, the joystick may be pushed forwards to move the implement in one direction, and pulled backwards to move the implement in another direction. A plurality of actuators 80 are in direct fluid communication with both the pilot pressure supply line 72 and the pilot pressure drain line 76. The actuator 80 may be an electro-mechanic actuator or an electro-hydraulic actuator. Based on the input to the operator control, the appropriate actuator 80 manipulates the active valve arrangement of the corresponding spool 32 of the implement valve 34 to transition from the neutral position to either the forward position or the reverse position.

Additionally, the pilot pressure supply line 72 and the pilot pressure drain line 76 are in fluid communication with the flow control valve 52 via a flow control valve actuator 82. As the appropriate actuator 80 manipulates the active valve arrangement of the corresponding spool 32, the flow control valve actuator 82 permits fluid flow in the supply conduit 28 through the flow control valve 52. The opening amount of the flow control valve 52 can vary based on the speed or magnitude at which the operator control is operated.

The spools 32 may be operated simultaneously or independently. As shown in FIG. 1, fluid can travel to one, some, or all of the spools 32. Additionally, the hydraulic system may include more or less than the two spools 32 shown in FIG. 1. When one of the spools 32 is in the forward position, fluid is provided from the supply conduit 28, through the spool 32, and to a first path 56 which is in fluid communication with the first variable volume chamber 60 of the piston-cylinder chamber. Additionally, when in the forward position, a second path 64, in fluid communication with a second variable volume chamber 68 of the piston-cylinder, is placed in fluid communication with the return conduit 40 via the spool 32. Therefore, as fluid is added to the first variable volume chamber 60, fluid drains from the second variable volume chamber 68 to the reservoir 24.

When the spool 32 is in the reverse position, fluid is provided from the supply conduit 28, through the spool 32, and to the second path 56 which is in fluid communication with the second variable volume chamber 60 of the piston-cylinder 36. Additionally, when in the reverse position, the first path 64, in fluid communication with the first variable volume chamber 60 of the implement, is placed in fluid communication with the return conduit 40 via the spool 32. Therefore, as fluid is added to the second variable volume chamber 60 of the piston-cylinder 36, fluid drains from the first variable volume chamber 60 to the reservoir 24. The only function of the spools 32 is selectively providing a fluid path to and from the piston-cylinder 36. Regardless of the direction (i.e., forward, reverse, closed) of the spool 32, the flow control valve 52 is capable of adjusting the flow rate independently. The use of the flow control valve 52 eliminates the need for individual pressure compensators assigned to each spool 32 or additional valve channels in each spool 32 of the implement valve 34.

Each of the first paths 56 and second paths 64 is fitted with a pressure relief valve 70 to limit the maximum pressure experienced by the implement. If the pressure within either of the paths 56, 64 exceeds a threshold value, fluid is bled from the paths 56, 64 to the return conduit 40 and the reservoir 24.

The load pressure (i.e., fluid pressure within the load sensing conduit 88) is provided to a load sensing pressure controller 92. The load sensing controller 92 responds to a change in load pressure by adjusting the displacement of the variable displacement pump 44, increasing or decreasing the flow in the supply conduit 28 (i.e., by making a minor modification to the swash angle of the variable displacement pump 44 in response to a change in load pressure). The load sensing controller 92 changes a nominal swash angle based on the difference in pressure between the supply conduit 28 and the load sensing conduit 88. In this way, the pressure upstream of the flow control valve 52 increases by a corresponding amount, thereby maintaining a constant pressure drop across the flow control valve 52. When the spools 32 are in the neutral position and the flow control valve 52 is not actuated, the load sensing conduit 88 is vented to the reservoir 24.

A security valve 96 (i.e., pump cutoff valve) is utilized to limit the maximum pump pressure. If the pressure within the supply conduit 28 exceeds a threshold value, the swash plate 48 of the pump 44 is swiveled back.

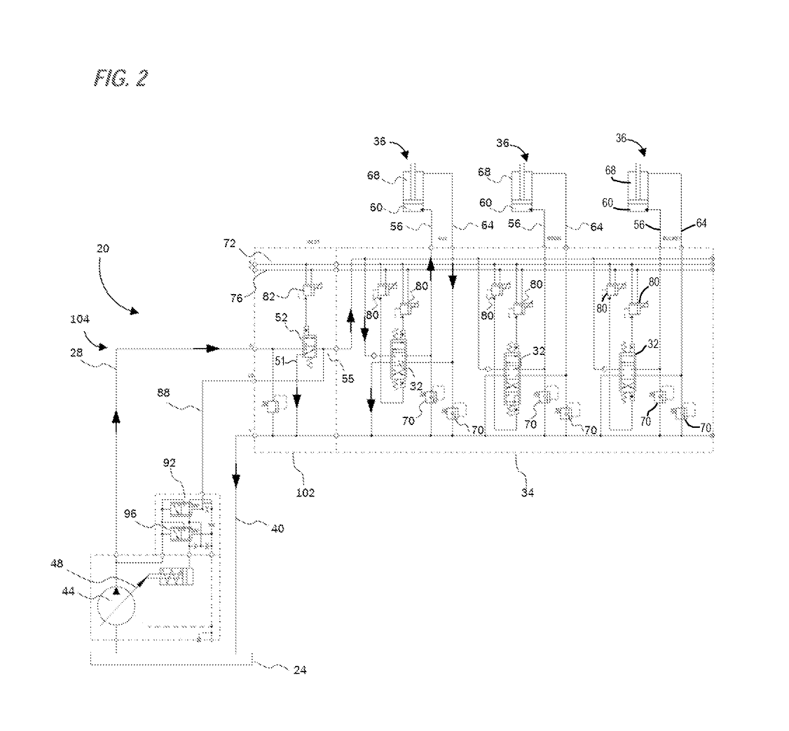

As shown in FIG. 2, when an operator actuates the operator control (not shown) to actuate the first piston cylinder 36 (i.e., the piston cylinder on the left as shown in FIG. 2) in a direction such that fluid is added to the first variable volume chamber 60, fluid pressure is transmitted along a path 104. Additionally, operation of the flow control valve actuator 82 and the appropriate actuator 80 allows fluid pressure from the pilot pressure supply line 72 to actuate both the flow control valve 52 and the first spool 32. Once in an actuated position, fluid is permitted to flow along the path 104, through the flow control valve 52 and the supply conduit 28, and either back to the reservoir 24 over flow control valve 52 and via the bypass pathway 51 or to the spool 32, where the fluid is routed to the first path 56. As fluid is added to the first variable volume chamber 60 of the first piston-cylinder 36, fluid is removed from the second variable volume chamber 68 of the first piston-cylinder 36 and is routed through the second path 64 to the spool 32. This return fluid continues through the return conduit 40 and the reservoir 24.

In order to maintain the pump margin after the valves 32, 52 open, the swash plate 48 of the variable displacement pump 44 swivels out to provide an increased flow to the supply conduit 28. The fluid pressure upstream of the flow control valve 52 is communicated to the load sensing controller 92 so the swash plate 48 of the variable displacement pump 44 swivels to reach a predefined set value and keep the pump margin across the flow control valve 52 constant. The flow through the supply conduit 28 can be adjusted by controlling the position of the flow control valve 52. As the operator control varies, the amount of fluid which passes through the flow control valve 52 varies, and the pump margin across the flow control valve 52 is maintained by altering the angle of the swash plate 48 of the variable displacement pump 44.

If multiple piston-cylinders 36 are operated at the same time, the corresponding spools 32 are operated in parallel. The flow control valve 52 is opened to a position that makes the pump swivel out to provide enough flow for the multiple piston-cylinders 36.

FIG. 2 is simplified to only show the flow of fluid where necessary for operation; however, fluid pressure would build against closed valves. The scenario shown in FIG. 2, as shown, assumes that all pressure relief valves 70 and the security valve 96 are in closed positions.

What is claimed is:

1. A hydraulic system for controlling one or more piston-cylinders of an implement, the hydraulic system comprising:
an implement valve including at least one spool operable to transition between a neutral position and an open position,
a variable displacement pump operable to move a fluid from a reservoir into a supply conduit and to the at least one spool; and
a flow control valve, distinct and separate from the at least one spool, located in-line with the supply conduit between the variable displacement pump and the at least one spool, and operable to simultaneously provide the fluid to the implement valve and to a bypass pathway;
wherein the bypass pathway extends from the flow control valve to the reservoir without intervening valving,
wherein each of the at least one spool is operable to permit increased fluid flow to a corresponding piston-cylinder of the implement when in the open position, and
wherein the variable displacement pump is operable to vary a flow rate to maintain a predetermined pump margin across the flow control valve.

2. The hydraulic system of claim 1, wherein no spool of the implement valve is provided with a flow control channel to control the flow rate through the variable displacement pump.

3. The hydraulic system of claim 2, wherein the hydraulic system does not include pressure compensators in direct fluid communication with any channels of the at least one spool.

4. The hydraulic system of claim 1, further comprising a load sensing conduit in fluid communication with the supply conduit, upstream of the at least one spool.

5. The hydraulic system of claim 4, further comprising a load sensing pressure controller in fluid communication with the load sensing conduit and operable to vary the flow rate through the variable displacement pump.

6. The hydraulic system of claim 1, wherein the flow control valve is electrically or electro-hydraulically actuated.

7. The hydraulic system of claim 1, wherein each spool of the implement valve is a closed center valve.

8. The hydraulic system of claim 1, wherein the flow control valve is located in an inlet section, removably coupled to the implement valve.

9. A method for controlling a spool of a hydraulic system to actuate a piston-cylinder of an implement; the method comprising:
providing a variable displacement pump in receptive fluid communication with a reservoir and in selective fluid communication with the spool via a flow control valve distinct and separate from the spool;
actuating the spool to establish fluid communication between the variable displacement pump and the piston-cylinder;
actuating the flow control valve simultaneously with the spool, to adjust a flow rate through the variable displacement pump independent of the spool position;
maintaining a predetermined pump margin across the flow control valve by providing the fluid to both the spool and a bypass pathway through the flow control valve,
wherein the bypass pathway extends from the flow control valve to the reservoir without intervening valving.

10. The method of claim 9, wherein the flow rate through the variable displacement pump is controlled without a pressure compensator in direct fluid communication with any channel of the spool.

11. The method of claim 19, further comprising:
providing a supply conduit from the variable displacement pump to the spool,
wherein maintaining the predetermined pump margin across the flow control valve further includes maintaining the predetermined pump margin in the supply conduit.

12. The method of claim 11, further comprising:
providing a load sensing conduit in fluid communication with the supply conduit;
providing a load sensing pressure controller in fluid communication with the load sensing conduit;
sensing a change in pressure within the load sensing conduit with the load sensing pressure controller; and
varying the flow rate through the variable displacement pump in response to the change in pressure.

13. The method of claim 9, wherein the variable displacement pump includes a swash plate configured to transition between a range of swash angles, and adjusting a flow rate through the variable displacement pump further includes adjusting the swash angle of the swash plate.

14. The method of claim 9, wherein the spool is a first spool and the piston-cylinder is a first piston cylinder and further comprising actuating a second spool of the hydraulic system simultaneously with the first spool to establish fluid communication between the variable displacement pump and a second piston-cylinder of the implement to actuate the second piston-cylinder.

15. A hydraulic system for controlling one or more piston-cylinders of an implement, the hydraulic system comprising:
an implement valve including at least one spool operable to transition between a neutral position and an open position,
a variable displacement pump operable to move a fluid from a reservoir into a supply conduit and to the at least one spool;
a return conduit operable to return the fluid from the at least one spool to the reservoir;
a flow control valve, distinct and separate from the at least one spool, located in-line with the supply conduit between the variable displacement pump and the at least one spool;
a bypass pathway extending from the flow control valve to the reservoir without intervening valving;
a first flow path from the variable displacement pump, across the flow control valve to the at least one spool; and
a second flow path across the flow control valve to the reservoir via the bypass pathway,
wherein the variable displacement pump is operable to vary a flow rate to maintain a predetermined pump margin across the flow control valve.

16. The hydraulic system of claim 15, wherein the first flow path and the second flow path are simultaneously operable to maintain the predetermined pump margin across the flow control valve.

17. The hydraulic system of claim 15, wherein the first flow path and the second flow path include no additional valving to modify the flow rate of the fluid.

18. The hydraulic system of claim 15, wherein each of the at least one spool is operable to permit increased fluid flow to a corresponding piston-cylinder of the implement when in the open position.

19. The hydraulic system of claim 15, wherein the flow control valve is located in an inlet section, removably coupled to the implement valve.

20. The hydraulic system of claim 15, wherein no spool of the implement valve is provided with a flow control channel to control the flow rate through the variable displacement pump.
